(19) United States
(12) Patent Application Publication
(10) Pub. No.: US 2015/0292246 A1
(43) Pub. Date: Oct. 15, 2015

(54) FITTING FOR A DOOR

(71) Applicant: DORMA Deutschland GmbH, Ennepetal (DE)

(72) Inventors: Falko SCHWEITZER, Schwelm (DE); Leo LORENZ, Wartenberg (DE)

(21) Appl. No.: 14/428,754

(22) PCT Filed: Oct. 17, 2013
(86) PCT No.: PCT/EP2013/071778

§ 371 Date: Apr. 27, 2015

(30) Foreign Application Priority Data
Oct. 17, 2012 (DE) 10 2012 020 450.7
Oct. 17, 2012 (DE) 10 2012 020 451.5

(51) Int. Cl. E05C 1/08; F21V 8/00; E05B 17/10; E05B 47/00; E05C 1/00; E05B 1/00

(52) U.S. Cl. CPC E05C 1/08; E05C 1/006; E05B 1/003; E05B 17/10; E05B 47/0012; G02B 6/001; E05B 2047/0072; E05B 2047/0067

(57) ABSTRACT

The invention relates to a system (1) for actuating a lock (2), comprising a function carrier (6), in particular a frame, a door actuating member (7), in particular a door handle, a bearing element (8), which is connected to the function carrier (6) in a torque-proof manner and serves for supporting the door actuating member at the function carrier, and a coupling, which comprises at least one coupling element (15) which is movable from a non-contacting position into a contacting position with a coupling counter-element (3) integrated into the lock (2), wherein, in the non-contacting position of the coupling element (15) with the coupling counter-element (3), the door actuating member (7) is freely rotatable without transferring a torque onto the lock (2), and wherein, in the contacting position of the coupling element (15) with the coupling counter-element (3), a torque applied to the door actuating member (7), is transferable, via the coupling element (15), onto the coupling counter-element (3) and thereby onto lock (2), wherein the coupling element (15), at least in the non-contacting position, is integrated into the bearing element (7).

The invention relates to a system for actuating a lock according to claim 1. The system comprises a function carrier, in particular a frame, a door actuating member, in particular a door handle, a bearing element, which is connected to the function carrier in a torque-proof manner and serves for supporting the door actuating member at the function carrier, and a coupling, which comprises at least one coupling element which is movable from a non-contacting position into a contacting position with a coupling counter-element integrated into the lock, wherein, in the non-contacting position of the coupling element with the coupling counter-element, the door actuating member is freely rotatable without transferring a torque onto the lock, and wherein, in the contacting position of the coupling element with the coupling counter-element, a torque applied to the door actuating member, is transferable, via the coupling element, onto the coupling counter-element and thereby onto the lock, wherein the coupling element, at least in the non-contacting position, is integrated into the bearing element.

Systems, comprising a door actuating member disposed at a function carrier are well known. Usually, in the known systems, the function carrier has the task of accommodating electronic components, such as a card reader or electronics, which is/are coupled to an antenna, for recognizing an authentication code emitted by a chip or by a card. Sometimes, the authentication components are also placed outside the function carrier and on a frontal faceplate covering the function carrier.

The authentication serves to unlock the lock and thereby to open the door. Unlocking the lock is realized in that the door actuating member is coupled to functional members of the lock, which act upon a locking cylinder of the lock or on a follower of the lock. Such doors, which are for exclusive authenticated traffic, are for example used in hotels or office premises or other premises, which can only be accessed by authorized people.

In general, door actuating members according to the idea of the application are understood to be preferably door handles, but also door knobs or electronical/electromechanical rotating knobs, by means of which, when manually actuated, a door can be unlocked or opened.

As already described, in particular electronical/electromechanical door handles or also rotating knobs are utilized to unlock a lock from a door side only after previous authentication, for example by means of a chip or an admission card. Without such authentication the electronical/electromechanical door handle or rotating knob, i. e. according to the idea of the application the door actuating member, is uncoupled from the associated follower disposed in the lock. Therefore, a rotational movement of the door handle or of the rotating knob does not result in a rotation of the follower, and therefore not in a rotation of the follower inside the lock. As, in the uncoupled case, the follower does not rotate with the door handle or with the rotating knob, the lock is not being unlocked and thus the door cannot be opened.

The known systems for actuating a lock are disadvantageous in that the support of the door actuating member at the function carrier and in particular the disposition of the coupling and of the authentication elements, such as the card reader, number pad or other electronic components, result in that the systems, in particular the function carriers, which together with a cover form the fitting for the known systems, have a large structural thickness, seen from the support pad of the fitting at the door leaf. Based on the structural thickness of the known systems, in particular of the known fittings, it is therefore for example not possible to install the systems in a door leaf in such a way that their surface terminates flush with the surface of the door leaf. In addition, the structural height of the known systems considerably limits their application possibilities. It is thus for example not possible to affix the known systems to a tubular frame door inside a door casing, because affixing the systems to the door casing would impede the opening of the door.

Therefore, it is the object of the invention to at least reduce the shortfalls of the state-of-the-art. It is in particular the object of the present invention to reduce the structural height of the known systems and to thereby increase their application possibility.

This problem is solved with a system according to the features of claim 1.

The inventive system for actuating a lock, which comprises a function carrier, in particular a frame, a door actuating member, in particular a door handle, a bearing element, which is connected to the function carrier, and a coupling in a torque-proof manner and serves for supporting the door actuating member at the function carrier, which includes at least one coupling element, which is movable from a non-contacting position into a contacting position with a coupling element integrated into the lock, wherein, in the non-contacting position of the coupling element with the coupling counter-element, the door actuating member is freely rotatable without transferring a torque onto the lock, and wherein, in the contacting position of the coupling element with the coupling counter-element, a torque applied to the door actuating member, is transferable, via the coupling element, onto the coupling counter-element and thereby onto lock, is configured according to the invention in that the coupling element, at least in the non-contacting position with the coupling counter-element, is integrated into the bearing element.

According to the idea of the application, “integrated” is to be understood in that the coupling element is accommodated to be fully integrated into the bearing element.

This solution offers the advantage of the inventive system being connectable to all locks, which include a coupling counter-element corresponding to the coupling element. In addition, the inventive system offers the advantage of the coupling element being integrated into the bearing element wherein the bearing element engages into the door actuating member such as to reduce the construction height of the inventive system, namely the structural height thereof to a minimum.

Advantageously, the coupling element is configured as a coupling pin, which consists of a square. Obviously, the coupling element may be likewise configured as a coupling pin having different shapes, such as a hexagon or as a Torx.

Preferably, the coupling counter-element, which is for example a follower serving for transmitting the torque of the door handle onto the lock, has a contour which non-positively and/or positively engages into the coupling element. The engagement of the coupling element into the coupling counter-element is realized in a preferred manner after the authentication of an authorized person at the system, such that a contacting position of the coupling element with the coupling counter-element is realized, wherein the coupling element engages at least partially in a torque-proof manner, in this case, preferably into the interior contour of the coupling counter-element. Preferably, for this purpose the coupling counter-element includes an interior contour for example in the shape of a square portion or a square borehole, wherein the locating surfaces for the coupling element are configured to be convex. This convex embodiment allows for at least partially compensating an alignment error of the lock with the follower disposed therein in the door leaf with regard to the door actuating member and in particular to the coupling element.

Preferably, the coupling element, which is for example a coupling pin, is driven by a drive element, i. e. is moved into the non-contacting position and into the contacting position with the coupling counter-element.

Preferably, the drive element consists of a motor with a spindle fitted thereon. In this case, the spindle of the motor engages in a female thread configured in the coupling element, whereby the coupling element is linearly movable at the spindle of the motor, i. e. in the direction of the coupling counter-element or in the opposite direction thereto.

So that the coupling element does not follow the rotational movement of the motor, which is transferred via the spindle onto the coupling element, the coupling element is preferably guided in a guiding element, which has a borehole, which corresponds to the contour, i. e. the exterior contour of the coupling element. As the coupling element is preferably configured as a square, the borehole in the guiding element, which results in guiding the coupling element, is configured as a square borehole as well.

Preferably, the guiding element is a guiding bushing, which in addition to the coupling element, likewise accommodates the drive element, namely the motor with the spindle configured thereat. Preferably, the motor is supported in this case in a motor pocket, which is insertable into the guiding element, in the present case preferably into the guiding bushing.

Preferably, the guiding element, which in the present case is preferably configured as a guiding bushing, assumes another elementary function, which serves the securing of the door actuating member at the bearing element. In order to be able to explain the function of the guiding element in more detail, the preferred support of the door actuating member, in the present case, in particular of the door handle at the bearing element needs to be understood.

The bearing element, which is preferably configured as a sleeve, is torque-proof connected to the function carrier. Preferably in this case, the bearing element is pushed at the side of the function carrier facing away from the door actuating member through a borehole of the function carrier, and is connected to the function carrier in a torque-proof manner by means of attachments. Obviously, it is likewise conceivable to configure the bearing element integrally with the function carrier.

At the end facing the door actuating member, the bearing element preferably includes securing elements, for example in the shape of latching catches or latching tongues, which either reach engagement in recesses for example ring-shaped grooves, which are configured in the interior walling of the door actuating member, when pushing on the door actuating member, or else a press sleeve, preferably a two-piece press sleeve is pushed into the door actuating member, wherein the two pieces of the press sleeve are pressed into the door actuating member to be spaced apart in such a way that the annular groove, formed by means of the distance between the two pieces of the press sleeve, serves for the engagement of the securing element of the bearing element.

If the door actuating member is secured by means of the securing element, in particular latched with the latching catches or latching tongues, it needs to be ensured that for example the latching catches or latching tongues do not get disengaged from their latching position, for example from the annular grooves. To prevent this from happening, for securing purposes by means of the securing elements, for example after latching the door actuating member with the bearing element, the guiding element with the drive element disposed therein and the coupling element connected to the drive element are introduced into the bearing element at the side of the function carrier facing away from the door handle. By inserting, respectively pushing the guiding element into the bearing element, it can thus be prevented that for example the latching elements pop out of, respectively get disengaged from the recesses, in this case preferably out of the annular grooves. This function of the guiding element ensures that the door actuating member, in this case in particular the door handle, after having introduced the guiding element into the bearing element, cannot be removed from the bearing element without applying violent force.

As the support of the door actuating member, in the present case, in particular of the door handle at the bearing element is rotation-free, i. e. the door actuating member is rotatable about the axis formed by means of the bearing element, and the bearing element accommodates the guiding element rotation-free about the axis thereof, for the purpose of transferring a torque from the door actuating member onto the coupling counter-element, not only does the coupling element need to engage in the coupling counter-element, but a torque transfer must also happen from the door actuating member onto the guiding element. Preferably, for guaranteeing this task, the door actuating member is configured as an open-end wrench, for example in the shape of a square, into which non-positively and/or positively engages the end of the guiding element facing away from the coupling counter-element. Preferably, for this purpose the end of the coupling element facing away from the coupling counter-element is configured in the contour of the open-end wrench, in the present case preferably as a square.

It is particularly preferred, if at least one piece of the press sleeve is configured as an open-end wrench, through which the torque transfer is realized from the door actuating member onto the guiding element.

As the guiding element, with its end facing away from the coupling counter-element, is at least in portions non-positively and/or positively connected to the door actuating member in a torque-proof manner, during an authentication procedure at the system, which results in a contacting position of the coupling element with the coupling counter-element, the motor disposed in a motor pocket can be controlled and moved into a rotational movement and then, via the spindle, drives the coupling element in the guiding element in the direction of the coupling counter-element, whereby subsequently by actuating the door actuating member in the contacting position, the torque, on account of the torque-proof support of the guiding element, is transferred onto the coupling counter-element.

For supplying energy to the system, in particular for supplying energy to the motor, preferably a battery is disposed in the door actuating member. For this purpose, preferably, the door actuating member includes a battery compartment, which is for example configured in the shape of a battery compartment of a pocket lamp. This configuration is particularly suitable, because the battery compartment, like battery compartments of a pocket lamp, is closed by a housing cover, which is screwed into the battery compartment. In this case, the housing cover forms a pole for locating the battery. This configuration is moreover suitable for facilitating the exchange of the battery. As the housing cover of the battery compartment can be unscrewed, “ejecting” the battery may be made easier in that, with the cover being unscrewed, the door actuating member, in the present case in particular the door handle, is rotated until the battery automatically falls out of the battery compartment.

Preferably, a sensor serves for monitoring the position of the coupling, more precisely for monitoring the position of the coupling element. Preferably, the sensor is able to detect the coupling conditions: uncoupled, i. e. coupling element is in a non-contacting position with the coupling counter-element, coupled, i. e. coupling element is in a contacting position with the coupling counter-element, and an intermediate position, which is between the non-contacting position and the contacting position of the coupling element with the coupling counter-element.

In a preferred manner, an optoelectronic sensor in the shape of at least one light barrier is suitable as the sensor, which detects the position of the coupling element, i. e. the coupling condition. Preferably in this case, the light barrier comprises an infrared LED (IR LED) and a phototransistor, which is placed at a distance opposite the IR LED. In this case, a printed circuit board, for example a CPU board, which is preferably supported inside the function carrier in a function zone, is directly equipped with the components of the light barrier, namely the IR LED and the phototransistor. Preferably, the printed circuit board is equipped on both sides, i. e. both surfaces of the printed circuit board are equipped with one respective light barrier. In this case, the printed circuit board advantageously serves as a shading element for preventing a cross-reaction, i. e. the projection of infrared beams of the one light barrier onto the phototransistor of the other light barrier.

As the coupling element is guided in the guiding element, for a light beam of the IR LEDs to pass therethrough onto the phototransistors of the respective light barrier, at least one through bore needs to be provided in the guiding element, which allows for the light beam to pass through. Now, if the coupling element is moved by the drive element in the direction of the coupling counter-element or in the opposite direction thereto, the position of the coupling element can be detected in the guiding element. Preferably, for this purpose the coupling element includes a solid area preventing the light beams from passing therethrough, into or in which area an area is configured in the coupling element, which allows for the light beams to pass through the boreholes of the guiding element. This area may be for example configured as an oblong hole or as an aperture, respectively a recess, in the coupling element.

Preferably, the function carrier, which is configured in the present case as a frame, does not include any corners. In other words, the function carrier, which is configured as a frame, following the exterior contour of the frame, is at least partially rounded. The risk of injury when operating the system, presently in particular the door actuating member, is thereby considerably reduced. In addition, such shaped function carrier complies with modern design standards, for example the one for smart phones, such that the system is in line with currently valid design trends.

Preferably, the function carrier can be manufactured in a cast zinc procedure, wherein the cast zinc is advantageous in that smallest structures or recesses representing the function zones within the function carrier can be configured. If the function carrier is embodied in one piece with the bearing element, obviously the bearing element can be represented at the function carrier in the cast zing procedure.

Preferably, the function carrier is configured in that the latter is subdivided into different function zones. As such, for example one function zone may be formed in that it accommodates the electronics, for example a CPU board with an attached RFID antenna. In this case, for example the printed circuit board can be likewise equipped with the light barrier, respectively the two light barriers, which are formed by means of the IR LEDs and the phototransistors. With the intention not to prevent transmission of electronic signals, for example from an authentication card or from a chip by means of a closed embodiment of the frame of the function carrier, which is manufactured from metal, respectively form cast metal, the frame, in the function zone accommodating the electronics and the antenna, is preferably interrupted by means of a cut, i. e. the circumferential exterior contour of the frame is interrupted. It is thus ensured that the frame does not act as a Faraday shield or as a coil, which would prevent signal transmission from an authentication card or from a chip to the electronics.

With the intention to protect the function zones of the function carrier, in particular the functional elements of the system disposed in theses function zones, from being accessed, the function carrier can be preferably closed, respectively covered by means of a cover element, for example a cover, in this case in particular in the shape of a frontal faceplate. For fitting the cover, respectively the frontal faceplate on the function carrier, in the area of the bearing element the frontal faceplate, respectively the cover includes a borehole through which the bearing element can pass. On the one hand, securing the cover on the function carrier is realized via attachment elements such as for example clips, which act between the function carrier and the cover element. On the other hand, the seating of the cover, respectively of the frontal faceplate on the function carrier is secured in that the door actuating member, in the present case in particular the door handle, reaches abutment on the bearing element on the surface of the frontal faceplate, respectively the cover facing the door handle. Correspondingly, the securing of the door actuating member at the bearing element likewise secures the frontal faceplate, respectively the cover, namely the cover element, in its abutment on the function carrier.

So that the cover element does not protrude beyond the function carrier equipped as a frame, the element is adapted to the exterior contour of the function carrier. In addition, preferably as explanation on how to actuate the system, the subdivided function zones are visually distinguished by means of the cover element. Different materials, such as glass or plexiglass in the area of the electronics and the antenna, are preferably utilized for this purpose, wherein this function zone is dissociated from a further function zone in that the further function zone is configured for example in the shape of a metal look or as metal. Preferably, the function zones are not only visually distinguished by means of different material features of the cover element, respectively the frontal faceplate, but also by means of different coloring.

With the intention to be able to distinguish, respectively to subdivide the function zones other than by means of different material features and the different colors in the cover element, preferably a fiber-optic light guide element is provided in the cover element, respectively in the frontal faceplate and between the function zones, which visually delimits the function zones in the cover element, respectively the frontal faceplate. In this case, the fiber-optic light guide element is preferably configured in the area of the bearing element, i. e. around the abutment area of the door actuating member at the cover element. Obviously, the fiber-optic light guide element may be configured independently, meaning it is not configured as a component linked to the cover element, which component connects for example a two-part frontal faceplate with each other and thereby separates function zones which are visually distinguished by the two parts of the frontal faceplate.

Obviously, the fiber-optic light guide element does not only serve as the visual separation of the function zones in the cover, respectively of the frontal faceplate, but also preferably serves to visually indicate the functional position of the door actuating member. The fiber-optic light guide element could thus for example emit a green signal indicating for example the successful authentication at the system. If, however a red signal is emitted by the fiber-optic light guide element, said light would indicate a non-authorization to actuate the system, meaning for example that then a door can not be opened.

As the coupling element is integrated into the bearing element, obviously the coupling element as well is integrated at least in the non-contacting position at least partially into the door actuating member and obviously into the guiding element as well. This disposition of the coupling element, namely into the guiding element which can be introduced into the bearing element, wherein the door actuating member reaches support on the bearing element, results in an extremely small construction height of the function carrier. Altogether and together with the cover element, which is placed in particular as a frontal faceplate onto the function carrier, respectively reaches abutment thereat, an overall construction height of the function carrier with the cover element, together forming the fitting of the system, can be kept at 10 mm or less.

When placing the system, more precisely when placing the function carrier onto the surface of the door leaf, the construction height of the system is to be understood as the depth. In this case, the depth of the system is measured from the surface of the cover element facing the door actuating member up to the surface of the door leaf, on which the function carrier is resting.

On account of the small construction height, the inventive system allows for the first time to recess the latter into a milled area of a door leaf. In addition based on its small construction height, the inventive system can be installed in tubular frame doors within a casing against which the door abuts.

Hereinafter, further measures enhancing the invention are illustrated in the following in detail in conjunction with the description of one preferred embodiment of the invention based on the Figures, in which:

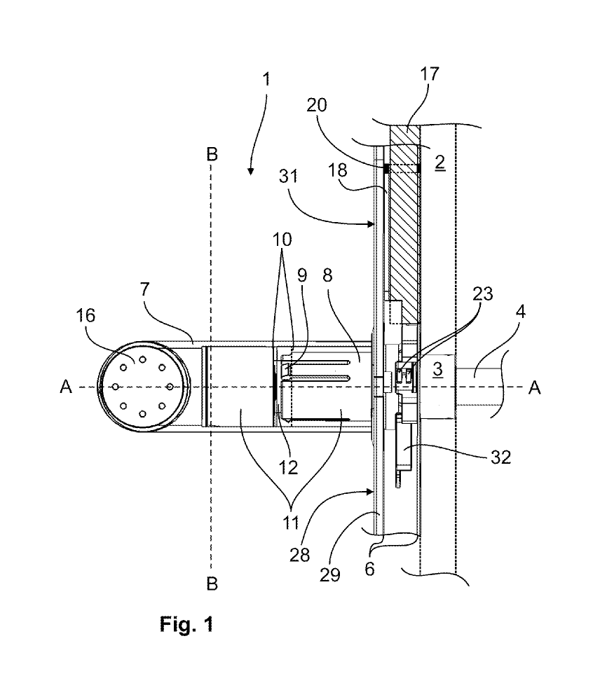

FIG. 1 shows an inventive system in a lateral view along the axis A-A in a sectional illustration,

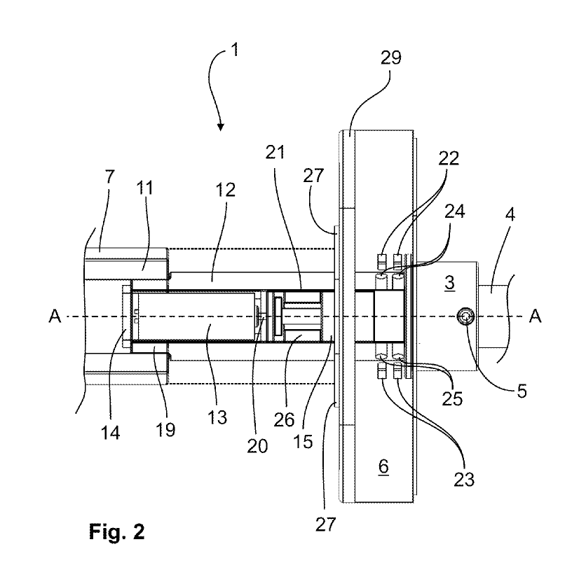

FIG. 2 shows the system of FIG. 1 in a section in a plane which is disposed lower than the one of FIG. 1, in a bottom view rotated by 90° about the axis A-A and thus seen frontally onto the axis B-B of FIG. 1,

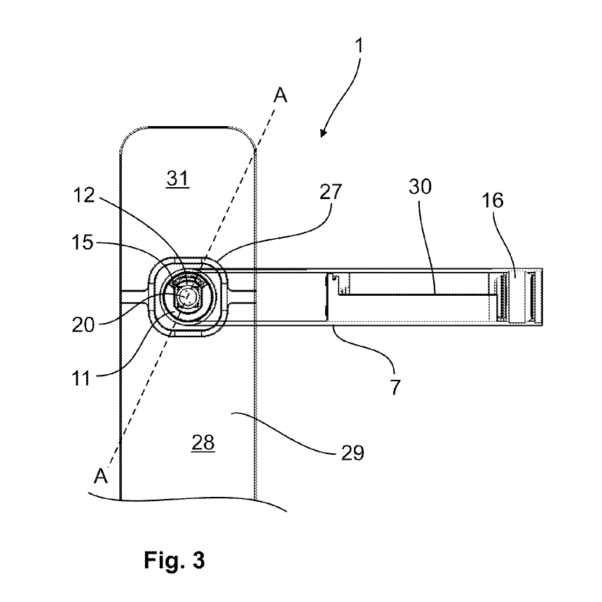

FIG. 3 shows the system of the previous Figures in a frontal view onto the axis A-A for torque transfer.

Throughout the different Figures, same parts are always identified by the same reference numerals, and therefore they will be normally only described once.

FIG. 1 shows a system 1 for actuating a lock 2, which, for the purposes of understanding, is just illustrated in the shape of a dashed line. In the Figures, just a coupling counter-element 3 in the shape of a follower being in operative connection with the lock 2 is illustrated as a functional element of the lock 2. In FIG. 1 from the right hand side, a square 4 engages into the coupling counter-element 3. In this case, the square 4 in its positive connection with the coupling counter-element 3 is secured by means of a headless screw 5. Usually, a door actuating member, in this case a non-illustrated door handle or door knob, is non-positively and/or positively connected to the square 4. In this case, the square 4 serves for a torque transfer from the door actuating member, which in the present case is not illustrated, onto the coupling counter-element 3 and thereby onto the lock 2. The torque transfer onto the square 4 and thereby onto the coupling counter-element 3 is realized in this case usually without a previous authentication, but is instead configured to be permanent. Therefore, the square 4 is preferably pushed into the coupling counter-element 3 from the inside of a door.

As illustrated in FIG. 1, the coupling counter-element 3 is bearing to the left side against a function carrier 6, which is configured as a frame. The door actuating member 7, in the shape of a door handle, is attached towards the left to the function carrier 6. The door actuating member 7 is located at a bearing element 8, which in the present case is formed as a sleeve, and is pushed into the door actuating member 7 from the side of the function carrier 6 facing away from the door actuating member 7. In this case, the bearing element 8 is connected to the function carrier 6 in a torque-proof manner by means of attachment elements, which in the present case are not illustrated. At least one securing element 9, which in the present case is configured in the shape of a latching tongue and engages in an annular groove 10, which is configured by means of the spacing of two pieces of a press sleeve 11, which are pressed into the door actuating member 7, is provided at the end of the bearing element 8, which engages with the door actuating member 7. Upon a rotational movement of the door actuating member 7, the annular groove 10, formed by means of the two spaced apart pieces of the press sleeve 11, can move with the rotational movement along the latching elements 9.

At least one piece of the press sleeve 11 is configured as an open-end wrench with which a guiding element 12 reaches positive engagement, which, at the side of the function carrier 6 facing away form the door actuating member 7, is pushed into the bearing element 8. When inserting the guiding element 12 into the bearing element 8, the latching elements 9 are pressed to the outside, so as to be secured in the annular groove 10 via the guiding element 12, which is introduced into the bearing element 8, from getting disengaged from the annular groove 10. At the end of the guiding element 12 facing the coupling counter-element 3, a retaining element 32, which is in operative connection with a non-illustrated door handle retention spring, is configured at the guiding element 12. The door actuating member 7 is thereby retained with the guiding element 12 in the initial position via a torque-proof connection, respectively after actuating the door actuating member 7, assisted by means of the door handle retention spring, it is moved back into the initial position.

The position of a drive element 13, preferably of a motor in a motor pocket 14, and the position of a coupling element 15, which is guided in the guiding element 12, and which are disposed within the bearing element 8, is illustrated in the following FIG. 2.

In the function carrier 6, above the bearing element 8 guided by means of the function carrier 6, a CPU board 17 with a RFID antenna 18 disposed thereat is disposed in a function zone 31 configured by means of the function carrier 6. With the intention to be able to transmit signals of the electronics and in particular of the antenna 18 disposed on the CPU board 17 towards outside the function carrier 6, respectively to receive the signals from outside, the function carrier 6 configured as a circumferential frame is interrupted by a cut 20a in the function zone 31. The cut 20a, respectively the interruption of the function carrier 6 surrounding the function zone 31 in the shape of a frame, ensures that the function carrier 6 does not act in this function zone 31 as a coil or as a Faraday shield.

FIG. 2 shows the system 1 of FIG. 1 in a view from the bottom rotated by 90° about the axis A-A. A housing cover 16 is configured at the door actuating member 7 which is configured as a door handle and illustrated in the Figure, at the free end of the door actuating member 7 viewed frontally in the Figure. In the present case, a non-illustrated battery is supported behind the housing cover 16 in a battery compartment 30, which is configured in the door actuating member 7 and serves as an energy supply for the system 1. The housing cover 16 and the battery compartment 30 linked thereto are configured just like the battery compartment of a pocket lamp. For this purpose, the housing cover 16 has a male thread, which is non-positively and/or positively brought into engagement with a female thread configured at the door actuating member 7. In this case, just like with a housing cover of a battery compartment of a pocket lamp, the housing cover 16 reaches abutment with a pole of a battery accommodated in the door actuating member 7, more precisely in the battery compartment 30.

For a better illustration of the position of the drive element 13, in the present case in the shape of a motor, which is supported in a motor pocket 14 within the guiding element 12, and for a better illustration of the position of the coupling element 15 in the guiding element 12, only the left part of the two pieces press sleeve 11 is illustrated, which is configured as an open-end wrench. Moreover, the bearing element 8 is omitted.

At its end facing away from the coupling counter-element 3, the guiding element 12, in the present case located on the left hand side in the Figure, is adapted to the contour of the part of the two-piece distance sleeve 11 formed as an open-end wrench, and configured as a square 19 in a tapering. In the section of the guiding element 12, which is introduced within the door actuating member 7 into the bearing element 8, the motor, which in the present case serves as the drive element 13, is retained in the motor pocket 14. A spindle 20 is connected to the motor and rotates together with the motor. The spindle 20 engages in a female thread of the coupling element 15. As the coupling element 15 is configured as a square and guided in a borehole 21, configured as a square, of the guiding element 12, the rotation of the spindle 20 in operative connection with the female thread of the coupling element results in the latter being guided in the guiding element 12 following the respective direction of movement of the motor 13 towards or away from the coupling counter-element 3.

For detecting the position of the coupling element 15, the CPU board 17 is equipped with a sensor, in the present case with two light barriers spaced apart in parallel with regard to each other, which respectively consist of an IR LED 22 and a phototransistor 23. In this case, the two light barriers are disposed on either side of the CPU board 17 and in such a way that the CPU board 17 disposed between the light barriers serves as a shading element between the light barriers. The light emitted by the IR LED 22 of the one light barrier can be thereby prevented from being incident on the phototransistor 23 of the other light barrier disposed on the other side of the printed circuit board 17.

In the non-contacting position of the coupling element 15 with the coupling counter-element 3 illustrated in the Figure in the present case, the coupling element 15 with its end facing the coupling counter-element 3 is located within the guiding element 12 in front of the first light barrier, in the present case on the left hand side in the illustration. The space located between the end of the coupling element 15 facing the coupling counter-element 3 and the coupling counter-element 3 and passing through the guiding element 12 is transparent for the light beams of the light barrier. In order to be able to emit light at all from the one IR LED 22, respectively the other IR LED 22 onto the opposite phototransistors 23, light entry holes 24 and light exit holes 25 are provided in the guiding element 12. If for example the coupling element 15 is driven via the spindle by the drive element 13 towards the coupling counter-element 3, the coupling element 15 passes both light barriers and thereby interrupts the light beams emitted by the IR LEDs 22 such that they are not detected any longer by the phototransistors 23. If the coupling element 15 is driven into the contacting position with the coupling counter-element 3, wherein the coupling element 15 is moved as far into the coupling counter-element 3 that an aperture 26 reaches the area of the light barriers. The light beam emitted by the IR LEDs 22 is thereby received again by the phototransistors 23. In the inventive system 1, said signals from the light barriers serve as the position detection of the coupling element 15 and in particular also to detect a contact position of the coupling element 15 with the coupling counter-element 3. Preferably, said signal of the position detection or also an authentication signal may be visually displayed by means of a fiber-optic light guide element 27.

As shown in FIG. 3, the fiber-optic light guide element 27 on the frontal faceplate 29 subdivides the function zones 31 and 28. The above described battery compartment 30, which is closed by means of the cover 16, can be seen at the door actuating member 7 illustrated in FIG. 3. In this case, the cover 16 forms a contact pole for the battery. The cover element 29, which in the present case, is configured as a frontal faceplate, is adapted to the exterior contour of the function carrier 6 configured as a frame. For this purpose, the cover element 29, in its upper circumference, is configured to be rounded.

The system 1 with the illustrated door actuating member 7 can be combined with other door actuating members, which may be configured as simple rotating knobs or as door handles. According to the idea of the invention, also a unilateral fixed door knob can be combined with the door actuating member of the system 1. It is likewise conceivable to combine the function zone 28 in addition to the door actuating member 7 with a rotating knob, respectively with an electronical/electromechanical rotating knob. It is likewise conceivable to equip the function zone 28 with a locking cylinder. In this case, the locking cylinder may be for example a profile cylinder, a round cylinder, an oval cylinder, which are configured as half cylinder and/or as double cylinders.

It is also conceivable to install the inventive system 1 in a knob cylinder, which is supported on the bearing element 8. It is also conceivable to generate an authentication via a key, which is introduced into a locking cylinder disposed in the function zone 28 of the function carrier.

In addition, the system 1 should not only be understood for the installation in doors. It is rather conceivable to utilize the system 1 for the installation of window actuating members.

The invention in its configuration is not limited to the above presented preferred exemplary embodiment of a system. On the contrary, a number of variants is conceivable, which make use of the illustrated solution, even with basically different types of embodiments. All features and/or advantages including the constructional details, spatial dispositions and method steps, which result from the claims, the description or the drawings, may be essential to the invention, both by themselves and in their most various combinations.

### LIST OF REFERENCE NUMERALS

1 system
2 lock
3 coupling counter-element
4 square
5 headless screw
6 function carrier configured as a frame
7 door actuating member
8 bearing element
9 securing element
10 annular groove
11 two piece press sleeve
12 guiding element
13 drive element
14 motor pocket
15 coupling element
16 housing cover
17 CPU board
18 RFID antenna
19 square for 12
spindle
20a cut
21 square borehole through 8
22 IR LED
23 phototransistor
24 light entry holes
25 light exit holes
26 aperture in 15
27 fiber-optic light guide element
28 function zone
29 cover element
30 battery compartment
31 function zone
32 retaining element for 12

1. The system (1) for actuating a lock (2) comprising a function carrier (6), in particular a frame, a door actuating member (7), in particular a door handle, a bearing element (8), which is connected to the function carrier (6) in a torque-proof manner and serves for supporting the door actuating member (7) at the function carrier (6), and a coupling, which comprises at least one coupling element (15) which is movable from a non-contacting position into a contacting position with a coupling counter-element (3) integrated into the lock (2), wherein, in the non-contacting position of the coupling element (15) with the coupling counter-element (3), the door actuating member (7) is freely rotatable without transferring a torque onto the lock (2), and wherein, in the contacting position of the coupling element (15) with the coupling counter-element (3), a torque applied to the door actuating member (7), is transferable, via the coupling element (15), onto the coupling counter-element (3) and thereby onto the lock (2), wherein the coupling element (15), at least in the non-contacting position, is integrated into the bearing element (8).

2. The system (1) according to claim 1,
characterized in
that, in the contacting position of the coupling element (15) with the coupling counter-element (3), the coupling element (15) is at least in portions non-positively and/or positively connected in a torque-proof manner to the coupling counter-element (3).

3. The system (1) according to claim 1 or 2,
characterized in
that the coupling element (15) is a coupling pin, which engages in a contour configured at the coupling counter-element (3).

4. The system (1) according to any of the preceding claims,
characterized in
that the coupling element (15) can be driven via a drive element (13).

5. The system (1) according to any of the preceding claims,
characterized in
that the drive element (13) is a motor.

6. The system (1) according to any of the preceding claims,
characterized in
that the coupling element (15) is guided in a guiding element (12) which can be inserted into the bearing element (8).

7. The system (1) according to any of the claims 4 to 6,
characterized in
that the drive element (13), at least in portions, is disposed in the guiding element (12).

8. The system (1) according to claim 6 or 7,
characterized in
that the guiding element (12), at least in portions, is non-positively and/or positively connected in a torque-proof manner to the door actuating member (7).

9. The system (1) according to any of the preceding claims,
characterized in
that the guiding element (12) engages in a contour configured at the door actuating member (7).

10. The system (1) according to any of the preceding claims,
characterized in
that at least one securing element (9), which engages in a recess configured at the door actuating member (7), is configured at the bearing element (8).

11. The system (1) according to any of the preceding claims,
characterized in
that the engagement of the securing element (9) in the recess of the door actuating member (7) is secured by means of inserting the guiding element (12).

12. The system (1) according to any of the preceding claims,
characterized in
that a sensor detects the position of the coupling element (15), in particular the contacting position, the non-contacting position and an intermediate position.

13. The system (1) according to claim 12,
characterized in
that the sensor optoelectronically detects the position of the coupling element (15).

14. The system (1) according to any of the preceding claims,
characterized in
that the function carrier (6), in particular the frame, following its exterior contour, is at least in portions configured to be rounded.

15. The system (1) according to any of the preceding claims,
characterized in
that the function carrier (6) is subdivided into function zones (28, 31).

16. The system (1) according to claim 15,
characterized in
that in at least one function zone (28, 31) of the function carrier (6), in which at least one antenna is disposed, the exterior contour configured as a circumferential frame of the function carrier (6) is interrupted.

17. The system (1) according to any of the preceding claims,
characterized in
that a cover element (29), in particular a frontal faceplate adapted to the exterior contour of the function carrier (6) and has a borehole for the passage of the bearing element (8), can be disposed at the function carrier (6).

18. The system (1) according to claim 17,
characterized in
that the cover element (29) visually distinguishes the subdivision into function zones (28, 31) of the function carrier (6).

19. The system (1) according to claim 18,
characterized in
that the function zones (28, 31) visually distinguished by the cover element (29) are separated from each other by means of a fiber-optic light guide element (27).

20. The system (1) according to claim 19,
characterized in
that the fiber-optic light guide element (27) serves as a visual signaling of the functional position.

21. The system (1) according to any of the preceding claims,
characterized in
that the drive element (13) configured as a motor is supported in a motor pocket (14), which can be introduced into the guiding element (12).

22. The system (1) according to any of the preceding claims,
characterized in
that the function carrier (6) and the cover element (29) together have a maximum construction height of 10 mm.
